(19) United States
(12) Patent Application Publication
(10) Pub. No.: US 2024/0259307 A1
(43) Pub. Date: Aug. 1, 2024

(54) STATELESS PROXY GATEWAY FOR SEGMENT ROUTING

(71) Applicant: NOVIFLOW INC., Montreal (CA)

(72) Inventor: Leo SCOTT, Montreal (CA)

(21) Appl. No.: 18/426,755

(22) Filed: Jan. 30, 2024

Related U.S. Application Data
(60) Provisional application No. 63/482,096, filed on Jan. 30, 2023.

(51) Int. Cl. H04L 45/00; H04L 45/74

(52) U.S. Cl. CPC H04L 45/66; H04L 45/566; H04L 45/74

(57) ABSTRACT

There is disclosed a proxy for providing network services for a packet comprising a header comprising at least one information field and being transmitted via a network wherein between nodes a protocol comprising at least one information field is used. The proxy receives packets encapsulated in the protocol, a parser configured to remove the header from the packets, and a mapper configured to transcribe the information fields of the header into at least one protocol information field. The packet and protocol are forwarded to a network service provider where a network service is executed on the parsed packet. Following completion of the at least one network service, the parsed packet and mapped protocol are returned to the mapper, the header reconstituted from the protocol information field, the reconstituted header prepended to the parsed packet and the reconstituted header and parsed packet transmitted via the connection to the network.

### CROSS REFERENCE TO RELATED APPLICATIONS

This application claims benefit under 35 U.S.C. § 119(e) of U.S. provisional application Ser. No. 63/482,096 filed on Jan. 30, 2023 which is incorporated herein in its entirety by reference.

### FIELD OF THE INVENTION

The present invention relates to a stateless proxy gateway for segment routing system and method.

### BACKGROUND TO THE INVENTION

Segment routing is a variant of source routing where a header is added to a packet which contain a list of segments which are used by subsequent nodes in the network, in particular as instructions to forward the packet to a specific destination.

One drawback of segment routing is that Segment Routing Unaware Network Services (SR-Unaware Network Services) are unable to provide services if the original packet is encapsulated with a Segment Routing (SR) header. A device such as a proxy gateway is therefore necessary between the segment routing network and the service to remove the SR header and present the original packet to the network service. Additionally, upon return of the packet from the service, the device must re-encapsulate the packet in an SR header.

A prior art approach is to save the SR-header in memory and restore it upon return. As it is difficult to predict how much memory is necessary and given that network switches typically have very limited memory, storing and restoring SR-header information is generally not feasible.

US20180375684 describes a network device implementing a SR gateway to store the SR headers removed from packet sent to the service functions. However, a stateless approach is achieved by storing meaningful information in the packet itself rather than on the device.

What is need therefore, and an object of the present, is an approach where SR-header information is mapped into existing Layer-2 information fields. By transporting SR-header information within the Layer-2 header, the memory to save the SR-header is not needed anymore.

### SUMMARY OF THE INVENTION

In order to address the above and other drawbacks, there is provided A proxy for providing stateless segment routing unaware network services for a Segment Routed (SR) packet comprising an SR header comprising at least one information field and being transmitted via an SR network, wherein between nodes a Layer-2 protocol comprising at least one Layer-2 information field is used The proxy comprises a connection to the SR network for receiving an inbound packet comprising an SR packet encapsulated in the Layer-2 protocol, a parser for removing the SR header from the SR packet, and a mapper for mapping the information fields of the removed SR header into the at least one Layer-2 protocol information field. The parsed packet and mapped Layer-2 protocol is forwarded to an SR unaware network service provider where at least one SR unaware network service is executed on the parsed packet. Following completion of the at least one SR unaware network service, the executed parsed packet and mapped Layer-2 protocol are returned to the mapper, the SR header reconstituted from the at least one Layer-2 protocol information field, the reconstituted SR header prepended to the executed parsed packet and the reconstituted SR header and executed parsed packet transmitted via the connection to the SR network.

There is also provided a non-transient computer readable medium containing program instructions for causing a computer to perform the method of connecting to an SR network for receiving an inbound packet comprising an SR packet encapsulated in a Layer-2 protocol, removing the SR header from the SR packet, mapping the information fields of the removed SR header into at least one Layer-2 protocol information field, forwarding the parsed packet and mapped Layer-2 protocol to an SR unaware network service provider, receiving the parsed packet and mapped Layer-2 protocol back from the SR unaware network service provider, reconstituting the SR header from the at least one Layer-2 protocol information field, prepending the reconstituted SR header to the executed parsed packet, and transmitting the reconstituted SR header and executed parsed packet into the SR network.

Additionally, there is provided a proxy for providing network services for a packet comprising a header comprising at least one information field and being transmitted via a network, wherein between nodes a protocol comprising at least one information field is used. The proxy comprises a network connection configured to receive inbound packets each comprising a packet encapsulated in the protocol, a parser configured to remove the header from each of the least one packet, and a mapper configured to transcribe the information fields of the removed header into the at least one protocol information field. The parsed packet and mapped protocol is forwarded to a network service provider where at least one network service is executed on the parsed packet. Following completion of the at least one network service, the executed parsed packet and mapped protocol are returned to the mapper, the header reconstituted from the at least one protocol information field, the reconstituted header prepended to the executed parsed packet and the reconstituted header and executed parsed packet transmitted via the connection to the network.

### BRIEF DESCRIPTION OF THE DRAWINGS

FIG. 1 provides a schematic diagram of a stateless proxy gateway for segment routing over IPv6 dataplane system in accordance with an illustrative embodiment of the present invention;

FIG. 2 provides a diagram of an IPV6 packet comprising a Layer-2 header, IPV6 header and SR header in accordance with an illustrative embodiment of the present invention;

FIG. 3A provides a schematic diagram of the encoding or mapping of an IPV6 packet comprising a Layer-2 header, IPV6 header and SR header prior to transmission to an SR unaware network service and in accordance with an illustrative embodiment of the present invention;

FIG. 3B provides a schematic diagram of the encoding or mapping of an IPV6 packet comprising a Layer-2 header, IPV6 header and SR header for subsequent routing via a segment aware network following reception from an SR unaware network service and re-encoding and in accordance with an illustrative embodiment of the present invention;

FIG. 4A provides a schematic diagram of the mapping of an IPV6 packet comprising a Layer-2 header, IPV6 header and SR header prior to transmission to an SR unaware network service and in accordance with an alternative illustrative embodiment of the present invention;

FIG. 4B provides a schematic diagram of the mapping of an IPV6 packet comprising a Layer-2 header, IPV6 header and SR header following reception from an SR unaware network service and in accordance with an alternative illustrative embodiment of the present invention; and

FIGS. 5A and 5B provided functional schematic diagrams showing the merging or mapping of CSIDs present in the original packet SR Header into the IPv6 destination address of the IPv6 header.

### DETAILED DESCRIPTION OF THE ILLUSTRATIVE EMBODIMENTS

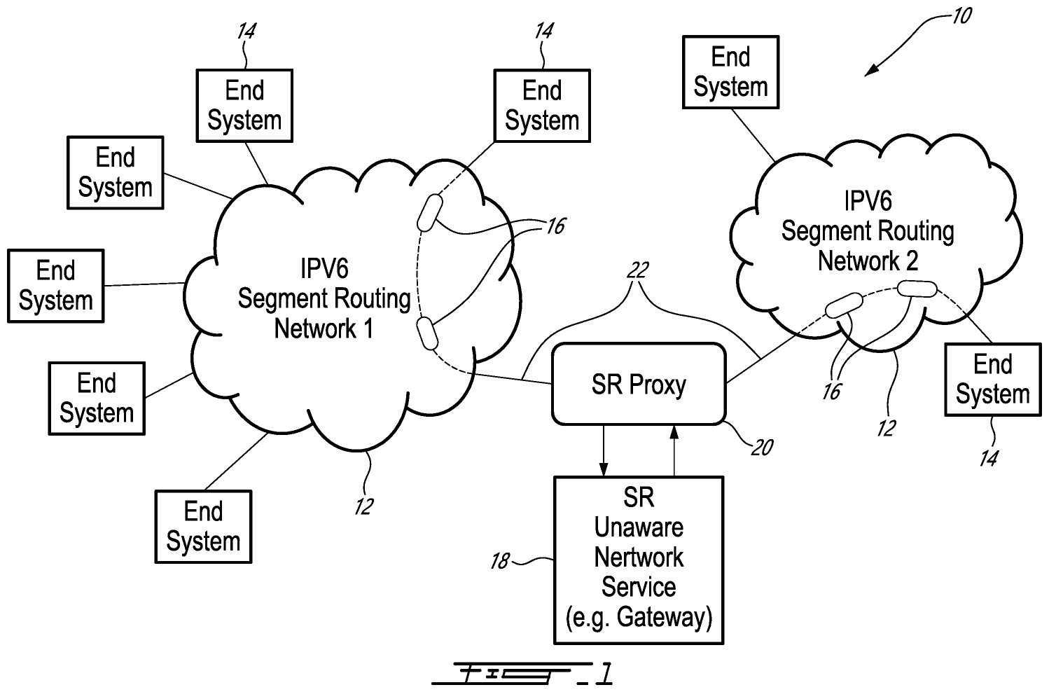

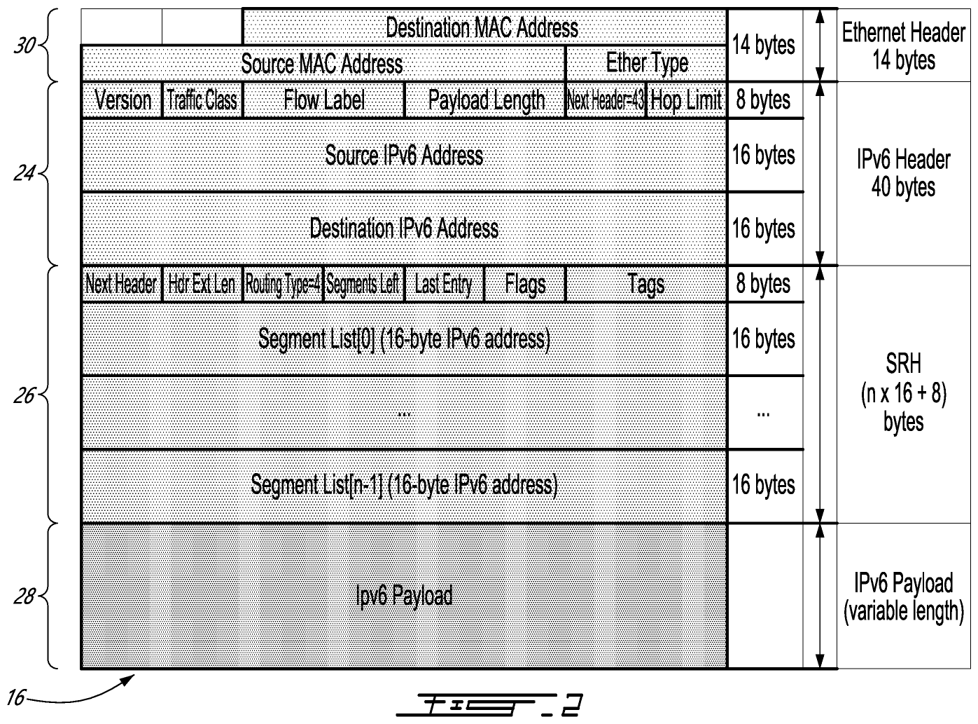

Referring now to FIG. 1, a stateless proxy gateway for segment routing over IPV6 dataplane system, generally referred to using the reference numeral 10, will now be described. The system 10 comprises an IPV6 Segment Routing (SR) networks 12 interconnecting a plurality of end systems/users 14. The end systems 14 communicate with other end systems 14 via the networks 12 using data packets 16 which include a SR header. Although the following discusses IPV6, in a particular embodiment the following could also apply to an IPV4 network.

Still referring to FIG. 1, network services may be provided at various points within the network 12. In some cases, it is wished to access SR unaware network services 18 which are unaware of the segment routing and unable to otherwise handle the SR header. In this regard and as will described in more detail below, an SR proxy 20 is provided. Although the network 12 is shown as comprising Network 1 and Network 2, in a particular embodiment Network 1 and Network 2 together form a single network 12, with the SR proxy 20 providing access to one or more SR unaware network services 18 within the single network 12.

Still referring to FIG. 1, in order to receive IPV6 SR Packets connections 22 are provided between the proxy 20 and the IPV6 SR networks 12. As known in the art, between nodes (or devices) in the networks 12, Layer-2 (or Data Link Layer) protocols, such as Ethernet, are provided to transmit IPV6 SR packets between nodes as payload.

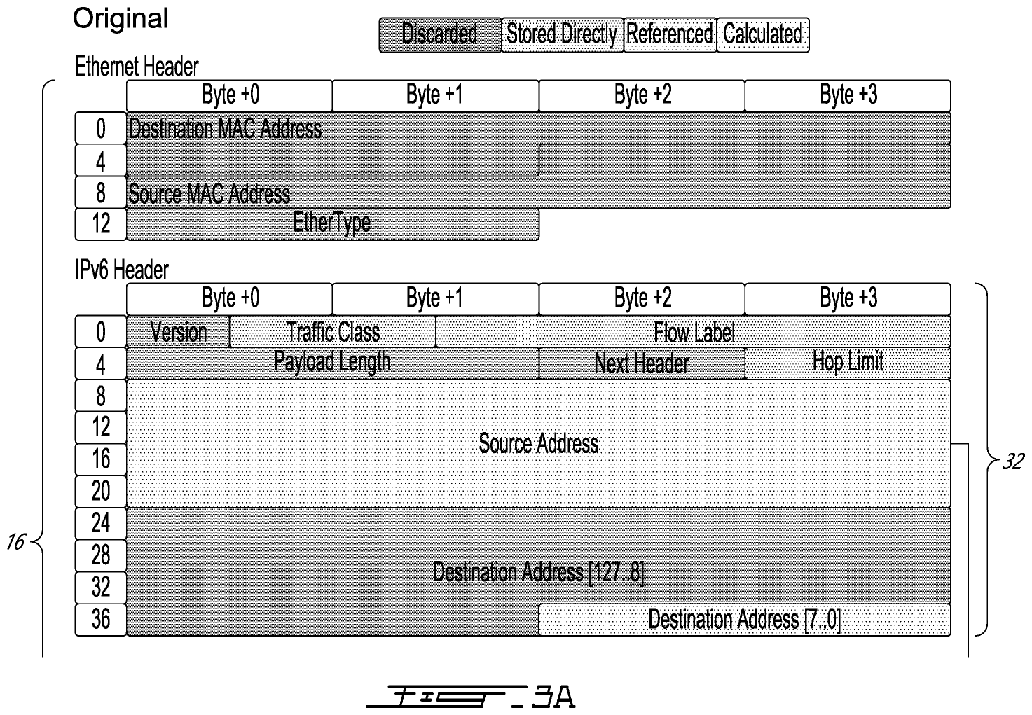

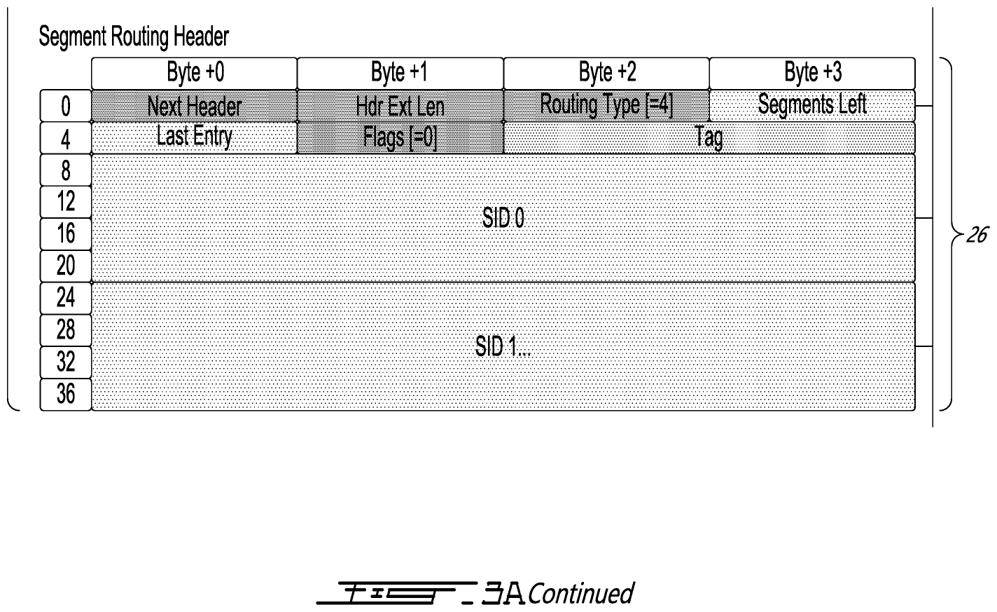

Referring now to FIG. 2, the IPV6 SR packet 16 comprises an IPv6 Header 24 comprising inter alia source and destination addresses, an SR Header 26 (which is optional when using CSID) and an IPv6 payload 28. Additionally, as discussed above, a Layer-2 header 30 is prepended to the IPv6 SR packet 16, in an illustrative embodiment an Ethernet type header comprising source and destination MAC addresses.

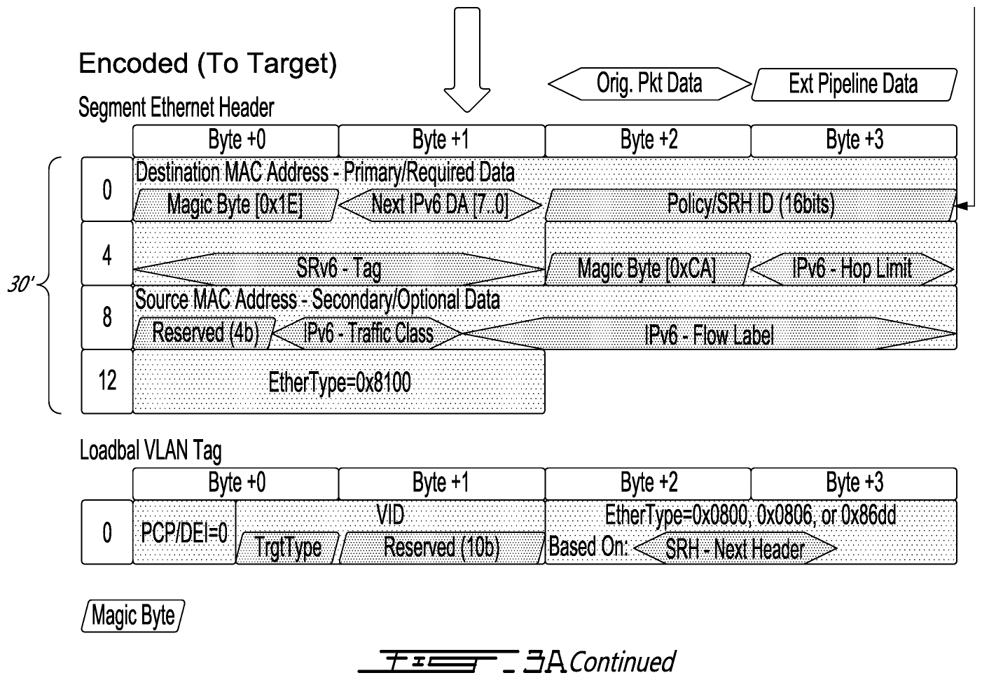

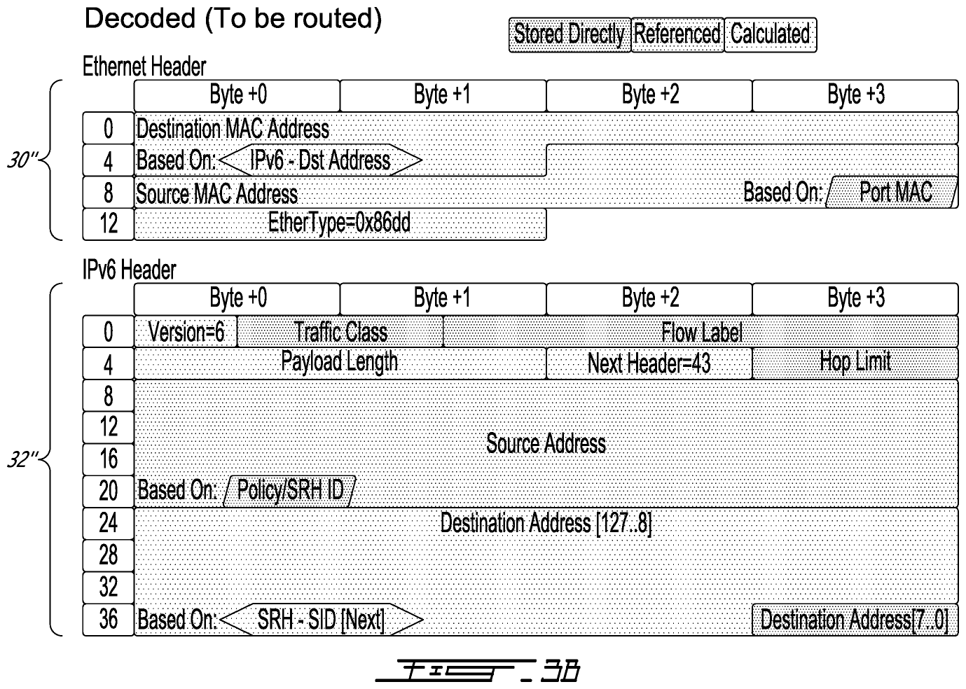

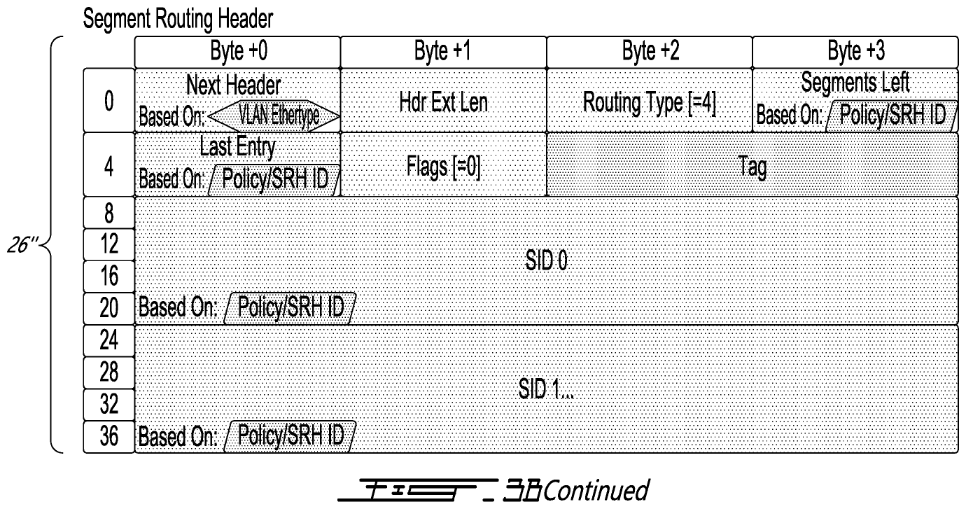

Referring now to FIG. 3A, upon reception of a packet 16 by the SR proxy 20, the IPV6 Header 24 and SR Header 26 is parsed and analysed. Information fields that are necessary to reconstruct the SR Header are mapped into the Layer-2 header 30′. Since conventional “bump-in-the-wire” network services do not modify or analyse the content of Layer-2 header, the Layer-2 header provides a convenient location to map SR Header 26 fields. Of note, is that for network services which are capable of parsing other tunnels it would also be possible to push a new tunnel in place of the SR Header and map SR Header fields in the new tunnel header (for example, VxLAN VNI, MPLS label, GRE key and the like).

Still referring to FIG. 3A, the Layer-2 header 30′ comprising the mapped SR fields and IPV6 payload (reference 28 in FIG. 2) is forwarded to the network service 18. On reception, the network service 18 executes its specific service (e.g., DDOS, firewall, gateway, encryption, etc.) and once completed returns the IPV6 payload with the Layer-2 header 30′ comprising the mapped SR fields to the proxy 20 untouched.

Referring to FIG. 3B in addition to FIG. 3A, on reception of the IPV6 parsed packet at the proxy 20 from the network service 18, the mapped Layer-2 header 30′ is parsed, and the information fields extracted. The Layer-2 header 30′' is then created and the SR IPV6 header 32″ and SR header 26″ are recreated or reconstituted based on the extracted information fields and prepended to the IPV6 payload (reference 28 in FIG. 2). The recreated packet 16′ then continues its journey in the IPV6 SR network 12.

Referring to FIG. 1 in addition to FIG. 3A, to process full SID packets, given the size of the IDs, in one embodiment the SID stack of the service chain is preconfigured, as well as the IPV6 source address. Each SID stack is identified as a unique chain ID. When a packet is to be sent to a SR-Unaware Network Service 18, and as illustrated in FIG. 3A, the SID stack is identified, the corresponding chain ID is stored in the MAC destination, the IPV6 traffic class, flow label, hop limit and SR Header tag are stored in the remaining available bits of the MAC destination and source, and the entire SRv6 encapsulation is removed (IPV6 and SR headers).

Referring to FIG. 3B in addition to FIG. 1 and FIG. 3A, when the Layer-2 header 30′ and IPV6/IPV4 payload returned from the SR-Unaware Network Service 18, a reconstituted IPv6 header 32″ and a reconstituted SR Header (reference 26″ in FIG. 3b) are added with the traffic class, flow label, hop limit and SRH tag copied from the mapped Layer-2 header 32′ to the corresponding fields, and the IPv6 source address and SID stack are set to the values that correspond to the chain ID that was stored in the Layer-2 header 30′.

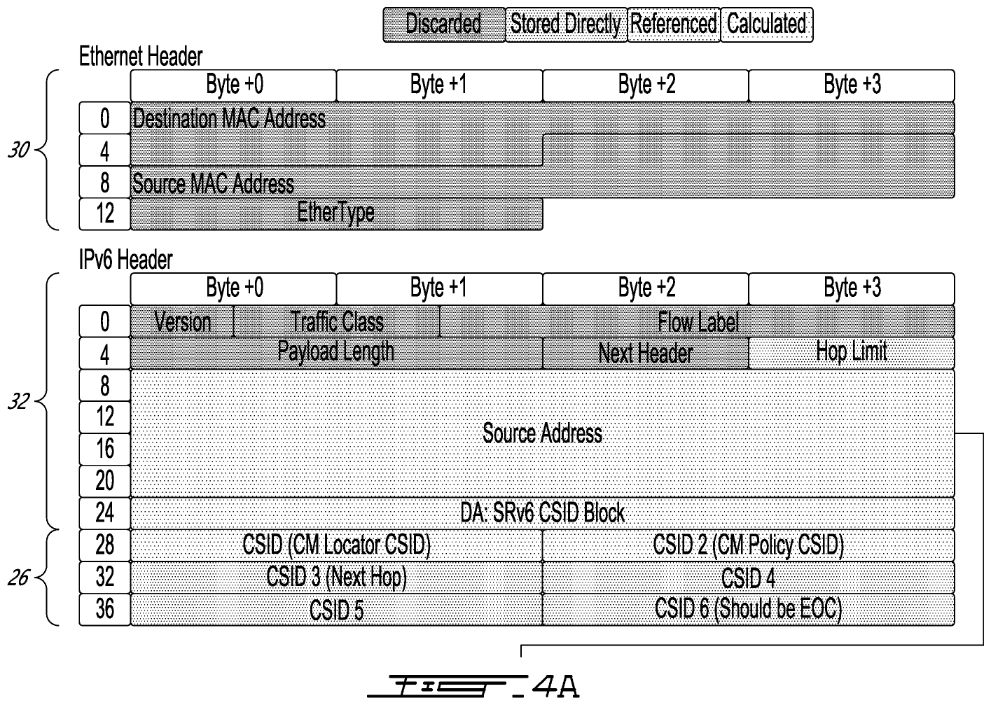

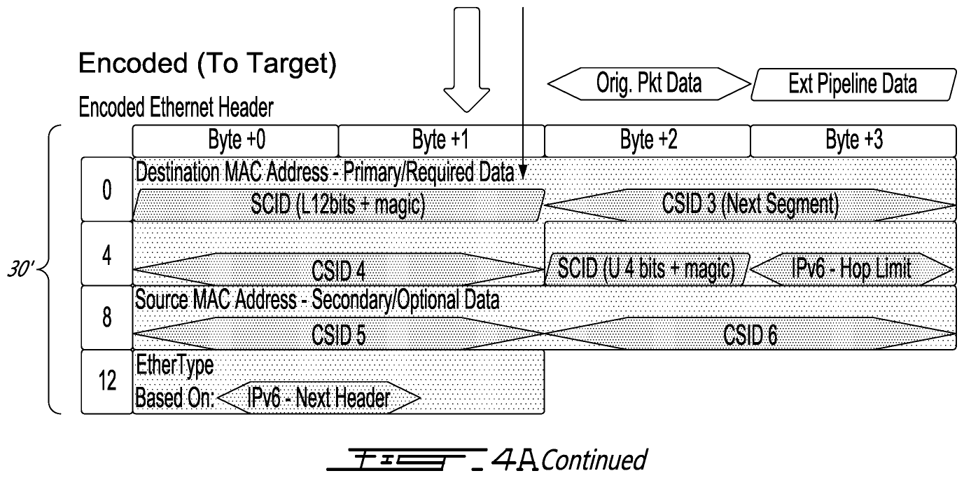

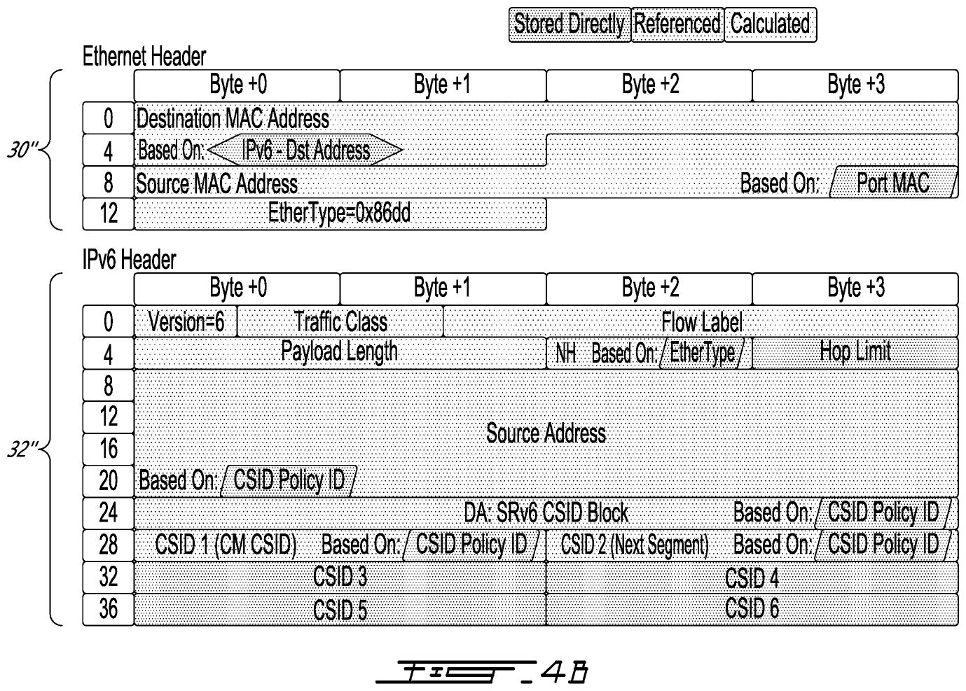

Referring to FIG. 4A, SRv6 was initially designed to use IPV6 addresses as Segment IDs (SIDs), but extensions are available that use a smaller ID, generally referred to as a Compressed SID (CSID) or Micro SID (uSID). In view of this, and in a particular embodiment, modified mappings of SRv6 fields into the mapped Layer-2 header 30′ have been developed for both CSID and full SID packets.

Of note is that, when CSIDs are used, and the SID stack left on the packet is not deep, the static configuration for the SIDs stack is not required due to their smaller size. The maximum amount of CSIDs that can be mapped into the Layer-2 header is four (4) of type f3216 or two (2) of type f3232, this number determines how many services can come after the currently processed SID. Also of note is that, although the present refers to f3232 CSIDs, but the same approach may apply to f3216 by combining pairs of CSIDs.

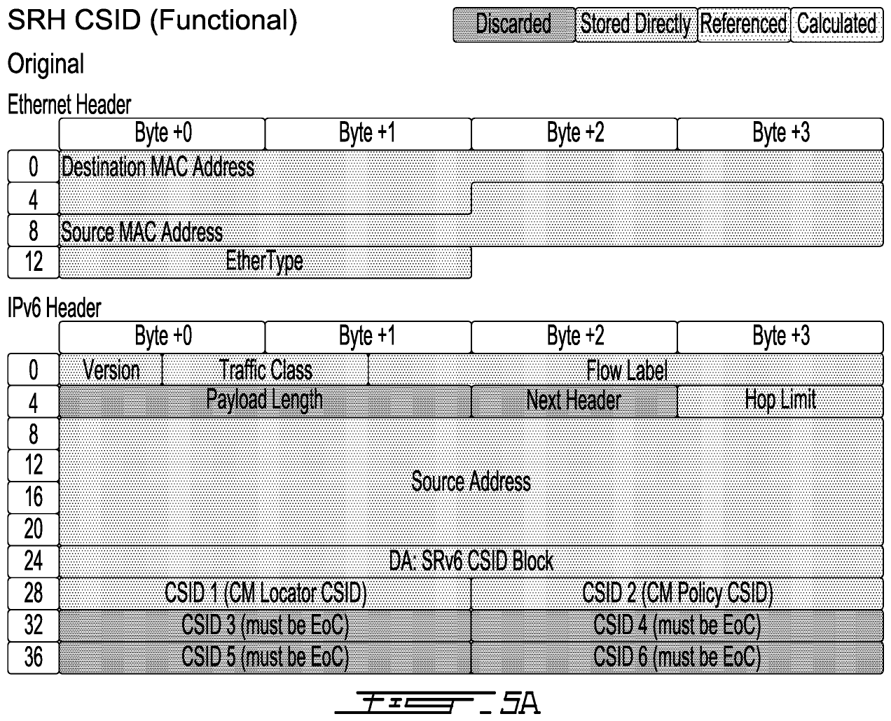

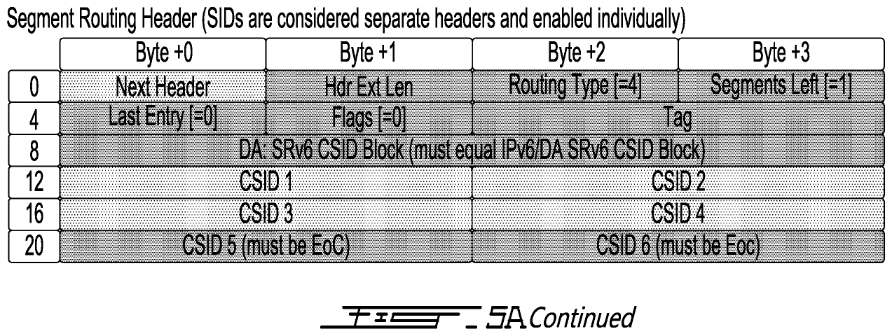

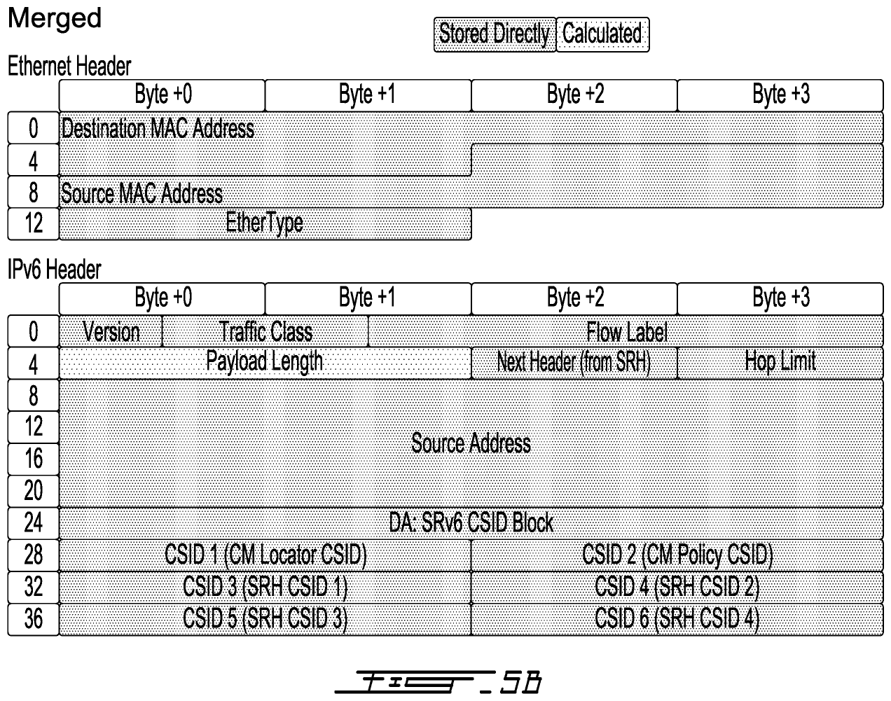

Referring to FIG. 4A in addition to FIG. 1, prior to sending a packet to the SR-Unaware Network Service 18, the four (4) CSIDs and the IPV6 hop limit are mapped into the MAC addresses, and the IPV6 header 32 and SRv6 header 26, if present, is removed. Note that this is possible in a first embodiment where there is no SR Header (i.e. when all remaining CSIDs are already included in the IPV6 destination address). It is also possible in a second embodiment, and as illustrated in FIG. 5A, where the following conditions are met: (1) the IPV6 destination address comprises only End-Of-Container CSIDs following the current SID, (2) the SR Header has last_entry=0, segments_left=1, includes the same locator block as the current SID (that is, the 32 bits before the CSID policy function), and a maximum of four (4) CSIDs are present in the SR Header. In the second embodiment the CSIDs can be merged to form a merged IPV6 destination address and the SR Header discarded. A functional diagram of this merging or mapping is illustrated in FIGS. 5A and 5B.

Referring to back FIG. 4B in addition to FIG. 1, when the packet returns from the SR-Unaware Network Service 18, a new IPV6 header 32″ is prepended, the 4 CSIDs and the hop limit copied to it from the Layer-2 header, the IPv6 source is set to the address of the interface used for transmission, and all other fields are set to default values or computed. Note that the SR header is not prepended, if it was present on the original packet, as this behaviour would be equivalent to merging the last SID into the IPV6 destination address and performing a penultimate segment pop.

Certain network services, depending on their type, vendor, and current configuration, can process packets encapsulated in tunnels such as VxLAN, GRE, MPLS, or L2MPLS. Using one of these tunnels would allow mapping more information from the original packet into their fields (e.g. VxLAN VNI, GRE key, MPLS label), thus reducing the number of fields that must be pre-configured or that are set to a default value on the packets sent back to the network using SRv6. Since the use of any of these tunnels would put a restriction on which network services would be compatible, their use would be configurable and optional.

Although the present invention has been described hereinabove by way of specific embodiments thereof, it can be modified, without departing from the spirit and nature of the subject invention as defined in the appended claims.

1. A proxy for providing stateless segment routing unaware network services for a Segment Routed (SR) packet comprising an SR header comprising at least one information field and being transmitted via an SR network, wherein between nodes a Layer-2 protocol comprising at least one Layer-2 information field is used, the proxy comprising:
a connection to the SR network for receiving an inbound packet comprising an SR packet encapsulated in the Layer-2 protocol;
a parser for removing the SR header from the SR packet; and
a mapper for mapping the information fields of the removed SR header into the at least one Layer-2 protocol information field;
wherein the parsed packet and mapped Layer-2 protocol is forwarded to an SR unaware network service provider where at least one SR unaware network service is executed on the parsed packet;
wherein following completion of the at least one SR unaware network service, the executed parsed packet and mapped Layer-2 protocol are returned to the mapper, the SR header reconstituted from the at least one Layer-2 protocol information field, the reconstituted SR header prepended to the executed parsed packet and the reconstituted SR header and executed parsed packet transmitted via the connection to the SR network.

2. The proxy of claim 1, wherein the SR network comprises an IPV6 SR network and the SR packet comprises an IPV6 SR packet.

3. The proxy of claim 1, wherein the at least one SR unaware network services comprises at least one of a DDOS service, a firewall service, a gateway service and an encryption service.

4. The proxy of claim 1, wherein the SR header is reconstituted from the at least one Layer-2 protocol information field by adding the traffic class, flow label, hop limit and SRH tag copied from the at least one Layer-2 protocol information field.

5. A non-transient computer readable medium containing program instructions for causing a computer to perform the method of:
connecting to an SR network for receiving an inbound packet comprising an SR packet encapsulated in a Layer-2 protocol;
removing the SR header from the SR packet;
mapping the information fields of the removed SR header into at least one Layer-2 protocol information field;
forwarding the parsed packet and mapped Layer-2 protocol to an SR unaware network service provider;
receiving the parsed packet and mapped Layer-2 protocol back from the SR unaware network service provider;
reconstituting the SR header from the at least one Layer-2 protocol information field;
prepending the reconstituted SR header to the executed parsed packet; and
transmitting the reconstituted SR header and executed parsed packet into the SR network.

6. The non-transient computer readable medium of claim 5, wherein the SR network comprises an IPV6 SR network and the SR packet comprises an IPV6 SR packet.

7. The non-transient computer readable medium of claim 5, wherein at least one SR unaware network service is executed on the forward packet.

8. The non-transient computer readable medium of claim 7, wherein the at least one SR unaware network service comprises at least one of a DDOS service, a firewall service, a gateway service or an encryption service.

9. The non-transient computer readable medium of claim 5, wherein the SR header is reconstituted from the at least one Layer-2 protocol information field by adding the traffic class, flow label, hop limit and SRH tag copied from the at least one Layer-2 protocol information field.

10. A proxy for providing network services for a packet comprising a header comprising at least one information field and being transmitted via a network, wherein between nodes a protocol comprising at least one information field is used, the proxy comprising:
a network connection configured to receive inbound packets each comprising a packet encapsulated in the protocol;
a parser configured to remove the header from each of the least one packet; and
a mapper configured to transcribe the information fields of the removed header into the at least one protocol information field;
wherein the parsed packet and mapped protocol are forwarded to a network service provider where at least one network service is executed on the parsed packet;
wherein following completion of the at least one network service, the executed parsed packet and mapped protocol are returned to the mapper, the header reconstituted from the at least one protocol information field, the reconstituted header prepended to the executed parsed packet and the reconstituted header and executed parsed packet transmitted via the connection to the network.

11. The proxy of claim 10, wherein the network comprises an SR network, the packet comprises an SR packet and the header comprises and SR header.

12. The proxy of claim 10, wherein the network comprises an IPV6 SR network and the packet comprises an IPV6 SR packet.

13. The proxy of claim 10, wherein the protocol comprises a Layer-2 protocol.

14. The proxy of claim 10, wherein the at least one network service comprises an SR unaware network service.

15. The proxy of claim 14, wherein the at least one SR unaware network services comprises at least one of a DDOS service, a firewall service, a gateway service and an encryption service.
